(19) United States
(12) Patent Application Publication
(10) Pub. No.: US 2013/0055926 A1
(43) Pub. Date: Mar. 7, 2013

(54) RECYCLING METHOD OF WASTE SCAGLIOLA

(71) Applicants: Yong-Soon Lee, Changwon-si (KR); Mu-Sik Noh, Jinhae-si (KR)

(72) Inventors: Yong-Soon Lee, Changwon-si (KR); Mu-Sik Noh, Jinhae-si (KR)

(73) Assignee: R&E CO., LTD., Changwon-si (KR)

(21) Appl. No.: 13/697,642

(22) PCT Filed: Jul. 9, 2010
(86) PCT No.: PCT/KR10/04496

§ 371 Date: Nov. 13, 2012

(30) Foreign Application Priority Data
May 19, 2010 (KR) 10-2010-0047140

(51) Int. Cl. C04B 32/02

(52) U.S. Cl. 106/287.17

(57) ABSTRACT

Provided is a method of recycling waste scagliola, which includes a pre-treating step, a pyrolysing step, a resin recycling step, and a filler recycling step. The pre-treating step includes storing the waste scagliola of a dry dust type, drying and storing the waste scagliola of a wet dust type, or pulverizing and storing the waste scagliola of a scrap type. The pyrolysing step includes receiving and heating a recycling raw material stored in the dust or granular type in the pre-treating step, and decomposing the raw material into a resin mixed gas and a filler mixed solid material. The resin recycling step includes receiving the resin mixed gas decomposed in the pyrolysing step, and recycling a resin from which impurities are removed by a purifying process. The filler recycling step includes receiving the filler mixed solid material decomposed in the pyrolysing step, and recycling a filler from which impurities are removed by a firing process. Thereby, the resin and filler are more effectively recycled from the waste scagliola, so that it is possible to prevent environmental pollution caused by disposing the waste scagliola, and to enhance an effect of reducing resource waste according to resource recycling.

### TECHNICAL FIELD

The present invention relates to a method of recycling waste scagliola, in which the waste scagliola is recycled to allow raw materials used when scagliola is manufactured to be recovered and recycled.

### BACKGROUND ART

With the pursuit of high-class and comfortable buildings, scagliola has been spotlighted as a building material. Scagliola is an artificial complex in which a feeling of natural marble is realized by blending natural ore powder or mineral with a resin component or cement, and then adding various pigments and additives to the blend.

Heretofore, wide use has been made of organic scagliola in Korea, in which an acrylic resin (organic material) called methyl methacrylane (MMA) is mixed with an inorganic filler. It is mixed at 35 to 45 wt % MMA and 45 to 65 wt % an inorganic filler, and the balance consists of additives. As the inorganic filler, aluminum hydroxide is mainly used, which has good characteristics in enhancing strength and wear resistance of the scagliola.

The scagliola is manufactured and processed into a desired size for use as a variety of functional goods such as washing tables, sink tables, kitchen counter tops, or interior decorations of public buildings such as counters, tables, etc. During processing, dust and scraps are generated. Due to various merits of the scagliola, its output rapidly increases each year. As such, a discharge amount of dust and scraps generated during processing and a discharge amount of the waste scagliola scrapped after being used are showing a rapidly increasing tendency.

However, since most of the waste scagliola has been treated as business wastes, and thus simply buried when scrapped, the scrapping incurs many expenses, and environmental problems such as soil pollution are caused. Further, there is a social issue in that we must continuously secure new landfills.

### DISCLOSURE

### Technical Problem

The present invention is directed to a method of recycling waste scagliola, in which a resin and a filler is more efficiently recycled from the waste scagliola, thereby making it possible to prevent air pollution caused by scrapping the waste scagliola, and to increase an effect of reducing resource waste by recycling resources.

### Technical Solution

One aspect of the present invention provides a method of recycling waste scagliola, which includes: a pre-treating step of storing the waste scagliola of a dry dust type, drying and storing the waste scagliola of a wet dust type, or pulverizing and storing the waste scagliola of a scrap type; a pyrolysing step of receiving and heating a recycling raw material stored in the dust or granular type in the pre-treating step, and decomposing the raw material into a resin mixed gas and a filler mixed solid material; a resin recycling step of receiving the resin mixed gas decomposed in the pyrolysing step, and recycling a resin from which impurities are removed by a purifying process; and a filler recycling step of receiving the filler mixed solid material decomposed in the pyrolysing step, and recycling a filler from which impurities are removed by a firing process.

### DESCRIPTION OF DRAWINGS

FIG. 1 is a flowchart illustrating a method of recycling waste scagliola according to an exemplary embodiment of the present invention;

FIG. 2 is a process diagram for explaining the pre-treatment and pyrolysing steps of FIG. 1;

FIG. 3 is a flowchart illustrating a resin recycling step;

FIG. 4 is a process diagram for explaining the resin recycling step of FIG. 3;

FIG. 5 is a process diagram for explaining the filler recycling step of FIG. 1; and

FIG. 6 is a flowchart illustrating a process of reusing gas discharged in the filler recycling step of FIG. 1.

### MODE FOR INVENTION

Hereinafter, exemplary embodiments of the present invention will be described in detail with reference to the accompanying drawings.

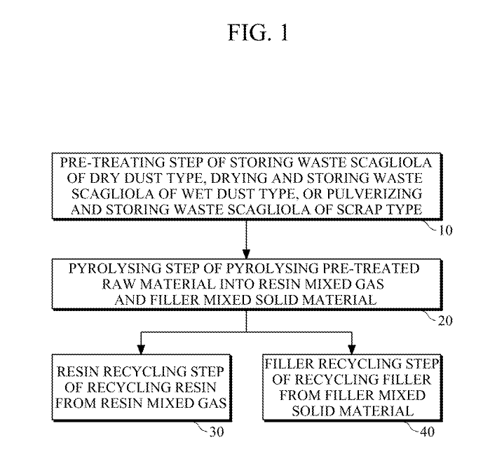

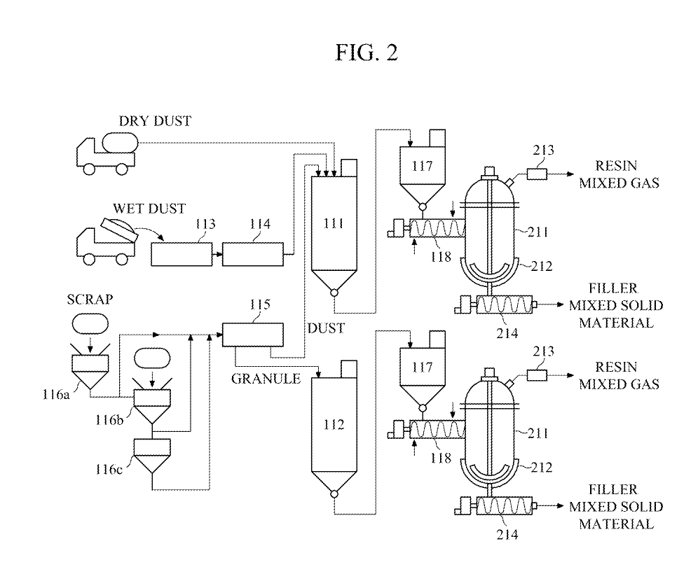

FIG. 1 is a flowchart illustrating a method of recycling waste scagliola according to an exemplary embodiment of the present invention, and FIG. 2 is a process diagram for explaining the pre-treatment and pyrolysing steps of FIG. 1.

First, referring to FIG. 1, the method of recycling waste scagliola is directed to recycling and reusing a resin and filler contained in the waste scagliola, and comprises a pre-treating step S10, a pyrolysing step S20, a resin recycling step S30, and a filler recycling step S40.

In the pre-treating step S10, the waste scagliola of a dry dust type is stored, the waste scagliola of a wet dust type is dried and stored, or the waste scagliola of a scrap type is pulverized and stored. Typically, the waste scagliola is generated in the process of manufacturing new scagliola or when used and scrapped. When scrapped, the waste scagliola may be in a dry dust type containing moisture of 10% or less, in a wet dust type containing moisture of 10% or more, or in a scrap type. Here, the “dust” type is defined to be composed of particles of 3 mm or less, and the “scrap” type is defined to be composed of granules of 3 mm or more.

In the pre-treating step S10, various types of waste scagliola as mentioned above are fed from the outside, and are pre-treated in the dry dust type containing moisture of 10% or less or in the granular type, so that it is possible to improve pyrolysing efficiency in the pyrolysing step S20.

In the pyrolysing step S20, the recycling raw material stored in the dust or granular type in the pre-treating step S10 is received and heated, and the raw material is decomposed into a resin mixed gas and a filler mixed solid material. The resin mixed gas is composed of a mixture of a resin, similar resin, and water decomposed in a gas state with fine dust, and the filler mixed solid material is composed of a filler of a solid state in which carbon and oil components are contained. The resin mixed gas is fed in the resin recycling step S30, and the filler mixed solid material is fed in the filler recycling step S40.

In the resin recycling step S30, the resin mixed gas decomposed in the pyrolysing step S20 is received, and a resin from which impurities are removed by a purifying process is recycled. The recycled resin may be variously used in respective industrial fields for the same use as existing methylmethacrylane (MMA). In the filler recycling step S40, the filler mixed solid material decomposed in the pyrolysing step is received, and a filler from which impurities are removed by a firing process is recycled. The filler is used to produce aluminum oxide (Al₂O₃) in the recycling process, and may be used as industrial raw materials such as fire-proofing materials.

According to the present embodiment as mentioned above, the method of recycling waste scagliola enables the resin and filler to be recycled and reused from the waste scagliola, so that environmental pollution caused by discarding of the waste scagliola can be prevented, and the waste of resources owing to the reuse of resources can be reduced.

Meanwhile, as illustrated in FIG. 2, in the pre-treating step S10, when the waste scagliola of the dry dust type is transported by a bulk truck, the transported waste scagliola of the dry dust type may be stored in a dust storage tank 111 by a pneumatic conveyer. The dust storage tank 111 may be configured so that clean air is discharged to the air via a bag filter.

In the pre-treating step S10, when the waste scagliola of the wet dust type is transported by a dump truck or a packing bag, the transported waste scagliola of the wet dust type is stored in a quadrilateral hopper 113, and is transferred to and dried in a drying furnace 114. Afterwards, the dried waste scagliola may be stored in the dust storage tank 111 by a pneumatic conveyer.

In the pre-treating step S10, when the waste scagliola of the scrap type is transported, the transported waste scagliola of the scrap type may be pulverized, and the pulverized scagliola may be separated into dust and granules by a separator 115. The separated dust may be stored in the dust storage tank 111, while the separated granules may be in a granule storage tank 112. Here, in the pyrolysing step S20a process of receiving the recycling raw material of the dust type from the dust storage tank 111 and pyrolysing the received material, and a process of receiving the recycling raw material of the granular type from the granule storage tank 112 and pyrolysing the received material are separately carried out. By separately carrying out the pyrolysing processes, efficiency can be increased because a time required for pyrolysing the recycling raw material of the dust type is different from a time required for pyrolysing the recycling raw material of the granular type.

The waste scagliola of the scrap type may be separately charged and pulverized step by step according to size. For example, when the transported scrap has a size of about 150 mm or more, it is pulverized by a primary pulverizer 116a. Then, the pulverized scrap is pulverized by a secondary pulverizer 116b and a third pulverizer 116c in turn, and then is transferred to the separator 115. When the transported scrap has a size from about 150 mm to about 12 mm, it is pulverized by the secondary pulverizer 116b. Then, the pulverized scrap is pulverized by the third pulverizer 116c, and then is transferred to the separator 115. When the transported scrap has a size of about 12 mm or less, it is pulverized by the third pulverizer 116c, and then is transferred to the separator 115.

Next, in the pyrolysing step S20, the recycling raw material of the dust or granular type is fed from the dust storage tank 111 or the granule storage tank 112 to a pyrolysis furnace 211 batch by batch using a raw material conveyer, and thus the recycling raw material is pyrolized into a resin mixed gas and a filler mixed solid material. In other words, the recycling raw material is pyrolized in a discontinuous way, i.e. in batches.

In order to enhance pyrolysis efficiency, a plurality of pyrolysis furnaces 211 may be installed. Further, the recycling raw material of the dust or granular type from the dust storage tank 111 or the granule storage tank 112 may be stored in a service tank 117 serving as a buffer, and then the recycling raw material stored in the service tank 117 may be fed to the pyrolysis furnace 211. In addition, the recycling raw material may be pre-heated by a pre-heating furnace 118, and then fed to and pyrolized in the pyrolysis furnace 211.

The recycling raw material in the pyrolysis furnace 211 may be agitated so as to continuously move in horizontal and vertical directions at the same time without a region where the recycling raw material in the pyrolysis furnace 211 is stagnant in the process of pyrolysing the recycling raw material. Further, the recycling raw material may be indirectly heated. This prevents the ignition of gas generated in the process of pyrolysing the recycling raw material in the pyrolysis furnace 211. A lower portion of the pyrolysis furnace 211 may be indirectly heated by an electric furnace 212 such that the recycling raw material has an internal temperature from 250° C. to 400° C. Here, a plurality of heaters are installed on the electric furnace 212 such that each region can be freely controlled.

When the filler mixed solid material has an oil content of 8% to 15%, the pyrolysing process is terminated. Thereby, the oil content of the filler mixed solid material is kept within a range from 8% to 15%. This enables the filler mixed solid material to be heated to an initial ignition temperature, and then to be fired by self exothermal reaction caused by its oil component without an external heat source. In this case, the filler recycling step is configured so that the filler mixed solid material is heated only to an ignition temperature and thus is fired by self exothermal reaction caused by its oil component. Meanwhile, excluding the firing caused by the self exothermal reaction, the pyrolysis may be terminated when the oil content is less than 8%.

The resin mixed gas pyrolized in the pyrolysing step S20 is discharged through an upper gas pipe of the pyrolysis furnace 211, and is fed in the resin recycling step S30. Here, the resin mixed gas passes through a dust removal filter 213 so as to remove dust therefrom, and then is fed in the resin recycling step S30. The filler mixed solid material is discharged through the lower portion of the pyrolysis furnace 211. The discharged filler mixed solid material contains a residual gas and a high-temperature oil component. Thus, the residual gas and some generated gas are discharged by a gas discharge unit, and the filler mixed solid material is transferred by an anti-cure conveyer 214.

The recycling raw material may be composed of MMA as the resin and aluminum hydroxide as the filler. In this case, in the pyrolysing step S20, the aluminum hydroxide may be decomposed into alumina of a solid state and water of a gas state, and the MMA may be decomposed in a gas state. The water and MMA of the gas state are fed in the resin recycling step S30, and the alumina of the solid state is fed in the filler recycling step S40.

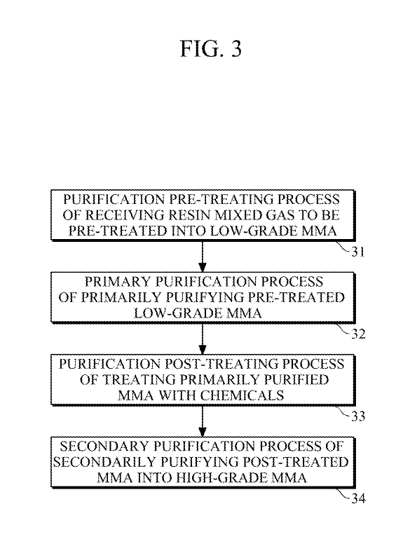

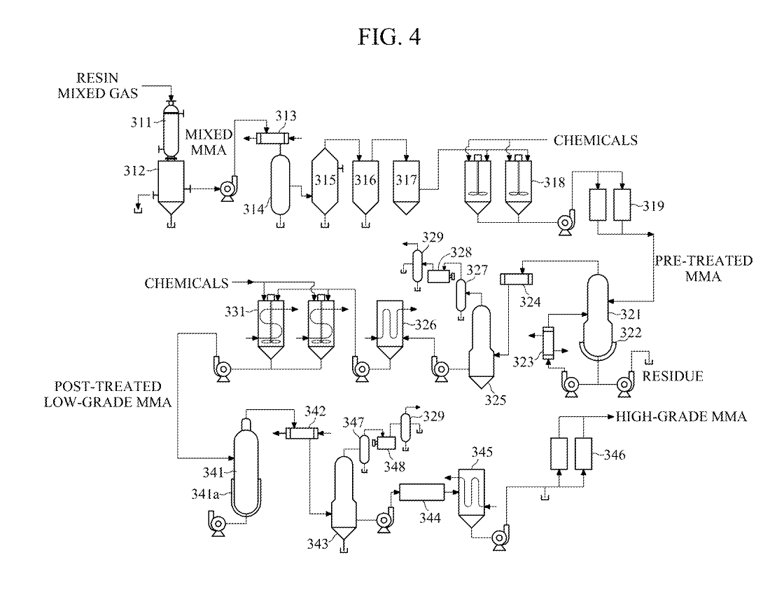

Meanwhile, the resin recycling step S30 may be performed as in FIGS. 3 and 4. Here, FIG. 3 is a flowchart illustrating a resin recycling step, and FIG. 4 is a process diagram for explaining the resin recycling step of FIG. 3.

Referring to FIGS. 3 and 4, the resin recycling step S30 comprises a purification pre-treating process S31 of receiving the resin mixed gas to pre-treat it into low-grade MMA, a primary purification process S32 of primarily purifying the pre-treated low-grade MMA, a purification post-treating process S33 of treating the primarily purified MMA with chemicals, and a secondary purification process S34 of secondarily purifying the post-treated MMA into high-grade MMA and packing the purified MMA.

First, the purification pre-treating process S31 comprises: a process of condensing the resin mixed gas passing through the filter 213 at the pyrolysis furnace 211, performing primary three-phase separation on the condensed gas, and extracting mixed MMA; a process of performing secondary three-phase separation on the extracted mixed MMA under a constant temperature and extracting low-grade MMA; a process of cleaning the extracted low-grade MMA, performing oil-water separation on the cleaned MMA, and storing the separated MMA; and a process of treating the stored MMA with chemicals and reserving the treated MMA.

For example, in the purification pre-treating process S31, the resin mixed gas is condensed with MMA, similar MMA, and water by a condenser 311 together with fine alumina powder, and also contains non-condensed gas. Then, the mixed MMA, the mixed alumina, the water, and the non-condensed gas are subjected to primary three-phase separation by a primary three-phase separator 312. Subsequently, the mixed MMA passes through a heat exchanger 313 to be maintained at a temperature of 10° C. to 15° C.

The mixed MMA under a predetermined temperature is precisely separated into mixed MMA, water, mixed alumina, and non-condensed gas by a secondary three-phase separator 314, and then is treated in the same way as the primary three-phase separating process. The low-grade MMA separated in the secondary three-phase separating process passes through a cleaner 315, thereby removing various foreign materials other than the MMA. Subsequently, the cleaned low-grade MMA is separated from undesired water by an oil-water separator 316, and is stored in a storage tank 317. Afterwards, to remove impurities from the stored low-grade MMA, the low-grade MMA passes through a chemical treatment tank 318 and then a filter 319, and is fed in the primary purification process.

Next, the primary purification process S32 may comprises a process of removing a residue from the pre-treated low-grade MMA by distillation, a process of condensing the low-grade MMA of a gas state from which the residue is removed and separating the condensed MMA into low-grade MMA of a liquid state and non-condensed gas, and a process of extracting the low-grade MMA of the liquid state.

For example, the pre-treated low-grade MMA is continuously fed to a purification distillation tank 321. To remove a residue from the fed low-grade MMA by distillation, the purification distillation tank 321 is heated by a heater 322, and thus the low-grade MMA is indirectly heated. In this process, evaporated low-grade MMA is sent to a condenser 324. To remove a residue from unevaporated low-grade MMA and improve efficiency, the low-grade MMA is heated by passing through a re-boiler 323, and then is fed to the purification distillation tank 321 again. In this manner, the low-grade MMA is circulated and evaporated, and is additionally heated by the re-boiler 323 in the circulating process, so that it is possible to improve productivity.

The evaporated low-grade MMA is condensed while passing through the condenser 324, is separated into the low-grade MMA of the liquid state and the unevaporated gas, and passes through a decanter tank 325 to be separated and discharged into the low-grade MMA of the liquid state and the non-condensed gas. The non-condensed gas is transferred to a deodorant furnace 329 via a vacuum chamber 327 by a vacuum pump 328. The low-grade MMA of the liquid state is transferred to and stored in a separation tank 326 having a cooler. To remove impurities from the low-grade MMA primarily purified in this process, the low-grade MMA is treated with chemicals in a post-treatment chemical tank 331 of the post-treatment purifying process S33, and then is fed in the secondary purification process S34.

Next, the secondary purification process S34 includes a process of removing a residue from the low-grade MMA of the liquid state by distillation, condensing the resulting MMA, and separating the condensed MMA into high-grade MMA of a liquid state and non-condensed gas, and a process of cooling the separated high-grade MMA of the liquid state in the transferring process, removing impurities from the cooled MMA, and packing the MMA.

For example, the post-treated low-grade MMA of the liquid state is fed to a purification distillation tank 341, and is indirectly heated by heating the purification distillation tank 341 using a heater 341a. This distilling process enables a residue to be removed from the low-grade MMA. The low-grade MMA of a gas state from which the residue is removed passes through a condenser 342, and thus is separated into high-grade MMA of a liquid state and non-condensed gas. Afterwards, the high-grade MMA of the liquid state and the non-condensed gas are separated and discharged via a decanter tank 343. The non-condensed gas is transferred to a deodorant furnace 329 via a vacuum chamber 347 by a vacuum pump 348. To completely liquefy the high-grade MMA of the liquid state, the high-grade MMA of the liquid state is cooled by a cooler 344, and is transferred to and stored in a separation tank 345 having a cooling unit. The high-grade MMA stored in the separation tank 345 is packed and marketed after foreign materials are removed therefrom by a filter 346. The overall secondary purification process may be carried out in a batch mode. That is, the low-grade MMA is injected only once, and then is subjected to secondary purification without being supplemented. After the above-mentioned resin recycling step S30 is carried out, a high-purity resin can be obtained.

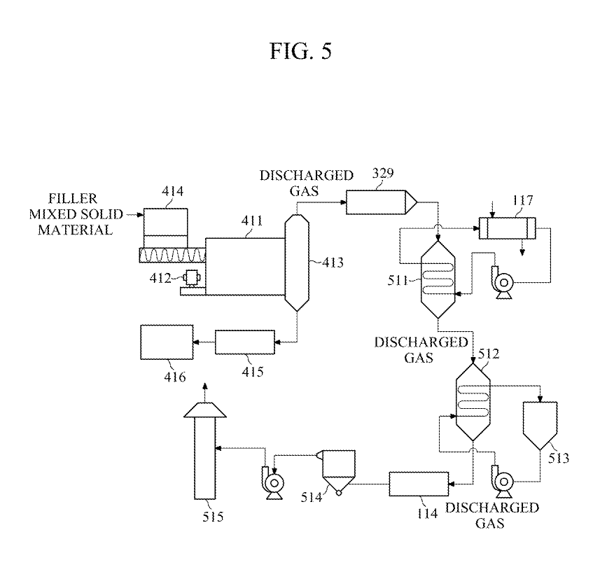

In the above-mentioned resin recycling step S30, an offensive odor can be removed from malodorous gas generated in the primary and secondary purification processes S32 and S34. For example, the malodorous gas is heated at the deodorant furnace 329, so that the offensive odor can be removed therefrom. The gas from which the offensive odor is removed passes through a bag filter to filter a residuum, and then is discharged to the air, so that it is possible to prevent air pollution. In the filler recycling step S40, an offensive odor can be removed from malodorous gas generated from a firing furnace 411 (see FIG. 5) using the above-mentioned process.

Meanwhile, as illustrated in FIG. 5, in the filler recycling step S40 the filler mixed solid material pyrolized in the pyrolysing step S20 is fed to and fired in the firing furnace 411. Here, the filler mixed solid material fed via the pyrolysing step S20 may be stored in a service tank 414 serving as a buffer, and be transferred to the firing furnace 411.

In the process of firing a solid material in which a filler is mixed with a part of resin, the solid material in which a filler is mixed with a part of resin may be fired by the firing furnace 411 capable of oxidizing the solid material up to 100%. When the filler mixed solid material passing through the pyrolysing step S20 has an oil content of 8% to 15%, the firing furnace 411 is heated only to an initial ignition temperature of the filler mixed solid material by a burner 412.

For example, when the firing furnace 411 has an internal temperature of 1000° C. or more, and when the filler mixed solid material has an internal temperature of 600° C. to 800° C., the burner 412 stops operating. Afterwards, the filler mixed solid material is fired by self exothermal reaction caused by its oil component. In this manner, the filler mixed solid material can be fired by the self exothermal reaction caused by its oil component without an external heat source, which can lead to an energy saving effect. The fired filler, for instance the alumina, is cooled by a cooler 415, and then is stored in a filler storage tank 416.

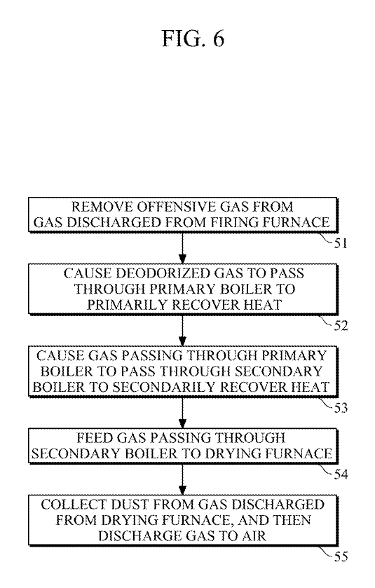

Meanwhile, the gas, which is generated in the filler recycling step S40 and is discharged through a hood 413, has a temperature of 700° C. to 1000° C., and may be used to recycle energy as illustrated in FIGS. 5 and 6. The gas discharged from the firing furnace 411 in the filler recycling step S40 passes through the deodorant furnace 329, thereby removing an offensive odor (S51). Then, the discharged gas passes through a primary boiler 511, thereby primarily recovering heat of the discharged gas (S52). Here, a fluid passing through the primary boiler 511 is heated by the heat of the discharged gas. The heated fluid is fed either in the pyrolysing step S20 so as to be able to be used to pre-heat the recycling raw material or in the resin recycling step S30 so as to be able to be used in the purification process. For example, the heated fluid may be fed to the pre-heater 118 for the pyrolysing step S20, the heat exchanger 313 for the purification pre-treatment process S31, or the re-boiler 323 of the primary purification process S32.

The discharged gas passing through the primary boiler 511 has a temperature of 300° C. to 450° C. The discharged gas having this temperature passes through a secondary boiler 512, thereby secondarily recovering the heat of the discharged gas (S53). Here, water passing through the secondary boiler 512 is heated by the heat of the discharged gas. The heated water may be fed to a hot-water tank 513. The water fed to the hot-water tank 513 may be used as hot water for the processes, heating water, or water for daily life. The discharged gas passing through the secondary boiler 512 has a temperature of 150° C. to 300° C. The heat of the discharged gas having this temperature is fed to the drying furnace 114 for the pre-treatment step S10 of drying the waste scagliola of the wet dust type (S54). The heat of the discharged gas fed to the drying furnace 114 is used to dry the waste scagliola of the wet dust type. The discharged gas passing through the drying furnace 114 passes through a dust collector 514, and is discharged to the air via a chimney 515 (S55). Thereby, it is possible to prevent air pollution.

According to the present invention, the various types of waste scagliola are fed from the outside, and pre-treated in a dry dust type or in a dry granular type, so that it is possible to improve pyrolysing efficiency. Thus, it is possible to recycle the resin and filler from the waste scagliola and to enhance their recycling efficiency. As such, it is possible to prevent air pollution caused by scrapping the waste scagliola, and it is advantageous to reduce resource waste by recycling resources.

Further, according to the present invention, the filler mixed solid material is caused to contain an oil component in the process of pyrolysing the recycling raw material, so that the filler mixed solid material can cause a self exothermal reaction to be fired without any external heat source after initial ignition, which leads to an energy saving effect. Further, the resin mixed gas is sequentially subjected to the purification pre-treatment, primary purification, purification post-treatment, and secondary purification, which leads to an effect of obtaining high-purity resin.

While the invention has been shown and described with reference to certain exemplary embodiments thereof, it will be understood by those skilled in the art that various changes in form and details may be made therein without departing from the spirit and scope of the invention as defined by the appended claims.

1. A method of recycling waste scagliola, comprising:
a pre-treating step of storing the waste scagliola of a dry dust type, drying and storing the waste scagliola of a wet dust type, or pulverizing and storing the waste scagliola of a scrap type;
a pyrolysing step of receiving and heating a recycling raw material stored in the dust or granular type in the pre-treating step, and decomposing the raw material into a resin mixed gas and a filler mixed solid material;
a resin recycling step of receiving the resin mixed gas decomposed in the pyrolysing step, and recycling a resin from which impurities are removed by a purifying process; and
a filler recycling step of receiving the filler mixed solid material decomposed in the pyrolysing step, and recycling a filler from which impurities are removed by a firing process.

2. The method of claim 1, wherein the pre-treating step comprises a process of pulverizing the scrap type of waste scagliola so as to be separated into dust and granules, and storing the separated dust and the separated granules in a dust storage tank and in a granule storage tank, respectively.

3. The method of claim 2, wherein the pyrolysing step comprises separately carrying out a process of receiving the recycling raw material of the dust type from the dust storage tank and pyrolysing the received material, and a process of receiving the recycling raw material of the granular type from the granule storage tank and pyrolysing the received material.

4. The method of claim 2, wherein the pre-treating step comprises a process of separately charging and pulverizing the scrap type of waste scagliola step by step according to size.

5. The method of claim 1, further comprising a deodorizing step of removing an offensive odor generated in the resin recycling step and the filler recycling step.

6. The method of claim 1, wherein the pyrolysing step comprises agitating the recycling raw material so as to continuously move in horizontal and vertical directions at the same time without being stagnant, and
pyrolysing the recycling raw material such that the filler mixed solid material maintains an oil content of 8% to 15%.

7. The method of claim 6, wherein the filler recycling step comprises heating a firing furnace to which the filler mixed solid material is fed only up to an ignition temperature of the filler mixed solid material such that the filler mixed solid material is fired by a self exothermal reaction caused by an oil component thereof.

8. The method of claim 1, wherein the pyrolysing step comprises a process of receiving the recycling raw material stored in the dust and granular type in the pre-treating step and storing the received raw material in a service tank, and a process of pre-heating the stored raw material via a pre-heating furnace and heating the pre-heated raw material.

9. The method of claim 1, wherein the recycling raw material comprises methyl methacrylane (MMA) as the resin and aluminum hydroxide as the filler, and
in the pyrolysing step, the aluminum hydroxide is decomposed into alumina of a solid state and water of a gas state, and the MMA is decomposed in a gas state.

10. The method of claim 9, wherein the resin recycling step comprises a purification pre-treating process of receiving the resin mixed gas to be pre-treated into low-grade MMA, a primary purification process of primarily purifying the pre-treated low-grade MMA, a purification post-treating process of treating the primarily purified MMA with chemicals, and a secondary purification process of secondarily purifying the post-treated MMA into high-grade MMA and packing the purified MMA.

11. The method of claim 10, wherein the purification pre-treating process comprises: a process of condensing the resin mixed gas, performing primary three-phase separation on the condensed gas, and extracting mixed MMA; a process of performing secondary three-phase separation on the extracted mixed MMA under a constant temperature and extracting low-grade MMA; a process of cleaning the extracted low-grade MMA, performing oil-water separation on the cleaned MMA, and storing the separated MMA; and a process of treating the stored MMA with chemicals and reserving the treated MMA,
the primary purification process comprises: a process of removing a residue from the pre-treated low-grade MMA by distillation, a process of condensing the low-grade MMA of a gas state from which the residue is removed and separating the condensed MMA into low-grade MMA of a liquid state and non-condensed gas, and a process of extracting the low-grade MMA of the liquid state, and
the secondary purification process comprises: a process of removing a residue from the low-grade MMA of the liquid state by distillation, condensing the resulting MMA, and separating the condensed MMA into high-grade MMA of a liquid state and non-condensed gas, and a process of cooling the separated high-grade MMA of the liquid state in a transferring process thereof, removing impurities from the cooled MMA, and packing the MMA, all the processes of the secondary purification process being carried out in a batch mode.

12. The method of claim 1, further comprising: a process of removing an offensive odor from the gas discharged in the filler recycling step and recovering heat from the discharged gas via a primary boiler; a process of feeding the recovered heat in the pyrolysing step to be used to pre-heat the recycling raw material or in the resin recycling step to be used for purification, a process of recovering the heat of the discharged gas passing through the primary boiler and using the recovered heat as heat of a hot-water boiler, and a process of using the heat of the discharged gas passing through the secondary boiler as heat for drying the wet dust type of waste scagliola.

13. The method of claim 1, further comprising a process of causing the resin mixed gas decomposed in the pyrolysing step to pass through a dust removal filter, removing dust from the resin mixed gas, and feeding the resin mixed gas in the resin recycling step.
